(19) United States
(12) Patent Application Publication
(10) Pub. No.: US 2025/0204606 A1
(43) Pub. Date: Jun. 26, 2025

(54) A Method for Controlling the Heating of a Susceptor of an Aerosol-Generating Device

(71) Applicant: JT International SA, Geneva (CH)

(72) Inventors: Grzegorz Aleksander Pilatowicz, Grens (CH); Eduardo Jose Garcia Garcia, Grand-Saconnex (CH)

(73) Assignee: JT International SA, Geneva (CH)

(21) Appl. No.: 18/846,427

(22) PCT Filed: Mar. 2, 2023
(86) PCT No.: PCT/EP2023/055281

§ 371 Date: Sep. 12, 2024

(30) Foreign Application Priority Data
Mar. 16, 2022 (EP) 22162527.0

(51) Int. Cl. A24F 40/57; A24F 40/465; H05B 6/10

(52) U.S. Cl. CPC A24F 40/57; A24F 40/465; H05B 6/108

(57) ABSTRACT

A method for controlling the heating of a susceptor of an aerosol-generating device is described. The susceptor is inductively heated by an oscillating circuit driven by an inverter. The method includes a pre-heating phase of the aerosol-generating device and a subsequent heating phase of the aerosol-generating device. A step of estimating or determining a temperature of the aerosol-generating device is performed during the pre-heating and heating phases. At the start of the pre-heating phase, the estimation or determination of the temperature is based on a determined resonant frequency of the oscillating circuit or a determined indicative electrical value of the oscillating circuit, e.g., a capacitor voltage. The determination or estimation of the temperature is transitioned to being based on a measured internal temperature of the aerosol-generating device.

### TECHNICAL FIELD

The present disclosure relates generally to a method for controlling the heating of a susceptor of an aerosol-generating device and an aerosol-generating device comprising a controller adapted to implement said method.

### TECHNICAL BACKGROUND

An aerosol-generating device generally comprises at least one reservoir arranged to store an aerosol-generating (or vaporizable) material which can be a solid or a liquid. The aerosol-generating material is heated, without burning, in order to generate an aerosol for inhalation. The aerosol is released into a flow path extending between an inlet and outlet of the device. The outlet may be arranged as a mouthpiece, through which a user inhales for delivery of the aerosol.

In some aerosol-generating devices, the aerosol-generating material is stored in a removable cartridge. Thus, when the aerosol-generating material is consumed, the cartridge can be easily removed and replaced.

The aerosol-generating material can be heated using different methods. One method consists in using induction heating. Such an aerosol-generating device thus comprises an induction heating system usually comprising an induction coil, an induction heatable susceptor and a power supply unit.

Thanks to the power supply unit or battery, electrical energy is provided to the induction coil. The induction coil thus generates an alternating electromagnetic field. The susceptor couples with the electromagnetic field and generates heat, which is transferred, for example by conduction, to the aerosol-generating material. Finally, the heated aerosol-generating material generates an aerosol.

For an optimized operating of the aerosol-generating device, there is a need to seek the highest possible energy efficiency during inductive heating.

The present disclosure aims at providing an improved method for controlling the inductive heating of a susceptor of an aerosol-generating device. More precisely, it aims at improving the energy efficiency when heating the susceptor. The method of the present disclosure further aims to ensure a consistent and high-quality vaping experience for the user of the aerosol-generating device.

The heating system of the aerosol-generating device should be able to heat the aerosol-generating material without burning it. Additionally, in order to provide a better user experience, the aerosol-generating material can be heated according to a predefined heating profile.

Accurate temperature control is crucial for heating in an aerosol-generating device. The aerosol-generating material can, for example, be heated too slowly or on the contrary, too fast. This can burn the aerosol-generating material and/or provide a poor user experience. The present disclosure aims to provide optimal temperature estimation during different operating phases of the aerosol-generating device, and in particular during an initial pre-heating phase and subsequent heating phase.

### SUMMARY OF THE DISCLOSURE

According to a first aspect of the present disclosure, there is provided a method for controlling the heating of a susceptor of an aerosol-generating device, the susceptor being inductively heated by an oscillating circuit driven by an inverter.

The method comprises a pre-heating phase of the aerosol-generating device and a subsequent heating phase of the aerosol-generating device, a step of estimating or determining a temperature of the aerosol-generating device being performed during the pre-heating and heating phases, wherein at the start of the pre-heating phase, the estimation or determination of the temperature is based on a determined resonant frequency of the oscillating circuit or a determined indicative electrical value of the oscillating circuit (i.e., estimation or determination of the temperature of the aerosol-generating device is based on a determined “parameter of the oscillating circuit” at the start of the pre-heating phase), and wherein the estimation or determination of the temperature is transitioned to being based on a measured internal temperature of the aerosol-generating device.

The indicative electrical value can be any value that is a function of, or is related or proportional to, the resonant frequency of the oscillating circuit or the operating frequency at which the inverter is driving the oscillating circuit. The indicative electrical value can be for example a current, a voltage or an impedance. The indicative electrical value can be the voltage of a capacitor of the oscillating circuit, for example.

The indicative electrical value can be determined using sensors, such as a voltage or current sensor.

The pre-heating phase is generally intended to pre-heat aerosol-generating material (or vaporizable material) stored in the aerosol-generating device, e.g., in a storage portion or compartment of the aerosol-generating device, and the heating phase is generally intended to heat the aerosol-generating material to generate aerosol.

At the start of the pre-heating phase, temperature estimation or determination is initially based on a determined parameter of the oscillating circuit. This provides accurate temperature estimation or determination during highly dynamic operation of the aerosol-generating device when the temperature of the susceptor is rapidly increasing towards a target temperature, which can be in a narrow range of about 230-320° C. for example. Although the estimated or determined temperature of the aerosol-generating device may typically be the temperature of the susceptor, it will be understood that it may be the temperature of any suitable part of the aerosol generating device, such as the aerosol generating material (or vaporizable material) or a storage portion or compartment of the device for storing aerosol-generating material, for example, the temperature of which may optionally be related to susceptor temperature, e.g., by an offset.

Subsequently, the temperature estimation or determination is transitioned to being based on a measured internal temperature of the aerosol-generating device. Using internal temperature measurements provides accurate temperature estimation or determination when the susceptor temperature is relatively stable. Temperature estimation or determination based on internal temperature measurements provided by one or more temperature sensors is also known to be less sensitive to parameter variation of the susceptor and the oscillating circuit. For example, estimating the susceptor temperature using the resonant frequency of the oscillating circuit may be more sensitive to the exact position of the susceptor relative to the induction coil of the oscillating circuit.

The pre-heating phase may be activated by a controller when a user activates a vaping button or by a trigger event such as the detection of a user puff, for example. During the pre-heating phase, the heating of the susceptor may be based on a predefined pre-heating temperature profile.

The pre-heating phase may be carried out for a predefined time interval after activation of the aerosol-generating device. The duration of the pre-heating phase may be fixed. The duration can be, for example, less than about 10 s. The duration of the pre-heating phase may be variable and may be determined by the controller based on other parameters. For example, the duration of the pre-heating phase may be determined as a function of the ambient temperature. At the end of the pre-heating phase, the controller will start the heating phase during which the heating of the susceptor may be based on a predefined heating temperature profile for aerosol generation.

The temperature estimation or determination may be transitioned to using internal temperature measurements (the “initial transition”) when the aerosol-generating device is transitioned from the pre-heating phase to the heating phase, i.e., at the end of the pre-heating phase. However, the temperature estimation or determination may also be transitioned to using internal temperature measurements during the pre-heating phase (i.e., before the end of the pre-heating phase) or after the heating phase has already been started by the controller. Put another way, the initial transition to using internal temperature measurements to estimate or determine the temperature of the aerosol-generating device does not have to coincide with the end of the pre-heating phase.

The temperature estimation or determination may be based on the determined parameter (e.g., the resonant frequency or indicative electrical value) of the oscillating circuit for a predefined time interval after the start of the pre-heating phase or after activation of the aerosol-generating device, before being transitioned to being based on a measured internal temperature of the aerosol-generating device. However, it may be preferred that the determination or estimation of the temperature is transitioned to being based on a measured internal temperature of the aerosol-generating device when the rate of change of the estimated or determined temperature falls below a first predefined value. For example, the first predefined value may be about 3 to about 7° C./s, and most preferably about 5° C./s. In this case, the temperature will initially be estimated or determined based on the parameter of the oscillating circuit during the pre-heating phase when the rate of change of the estimated temperature will be higher than the first predefined value. At some point, as the heating of the susceptor is controlled, the rate of the change of the estimated temperature will start to decrease—e.g. as the target temperature is reached or approached. When the rate of change of the estimated or determined temperature falls below the first predefined value, the determination of the estimated or determined temperature will transition to being based on internal temperature measurements. Using the rate of change of the estimated or determined temperature to switch between using the parameter of the oscillating circuit and internal temperature measurements means that the process of estimating or determining the temperature of the aerosol-generating device is independent of other control triggers such as the end of the pre-heating phase, for example, and results in optimal accuracy during the operation of the device.

After the initial transition, the temperature of the aerosol-generating device may be estimated or determined based on a measured internal temperature of the aerosol-generating device until the end of the heating phase.

Alternatively, after the initial transition, the determination of the estimated or determined temperature may be transitioned between being based on the measured internal temperature of the aerosol-generating device and the determined parameter of the oscillating circuit. In particular, after the initial transition, the determination of the estimated or determined temperature may be transitioned to be based on a determined parameter of the oscillating circuit if the rate of change of the estimated temperature exceeds a second predefined value. For example, the second predefined value may be about 8 to about 12° C./s, and most preferably about 10° C./s. The determination of the estimated or determined temperature may subsequently be transitioned to being based on the measured internal temperature if the rate of change of the estimated temperature falls below the first predefined value (or another predefined value). This transitioning or switching between using the measured internal temperature and the parameter of the oscillating circuit to estimate or determine the temperature of the aerosol-generating device may continue until the end of the heating phase so that optimal accuracy is obtained during those periods when the temperature of the susceptor is rising or falling rapidly (dynamic response) and those periods when the temperature is relatively stable. In some arrangements the threshold for transitioning or switching can be selected such that if a user takes a puff during the heating phase it does not trigger a transition between using the parameter of the oscillating circuit and the measured internal temperature of the aerosol-generating device.

When the temperature is being estimated or determined using the parameter of the oscillating circuit, including the resonant frequency or an indicative electrical value such as the voltage of a capacitor of the oscillating circuit, the controller may continue to receive internal temperature measurements from one or more temperature sensors. But the internal temperature measurements are not used in the process to estimate or determine the temperature of the aerosol-generating device for controlling heating of the susceptor. Similarly, when the temperature is being estimated or determined using internal temperature measurements, the controller may continue to determine the resonant frequency of the oscillating circuit as described in more detail below, or continue to receive indicative electrical value measurements. But the determined resonant frequency or indicative electrical value is not used in the process to estimate or determine the temperature of the aerosol-generating device for controlling heating of the susceptor.

The resonant frequency may be determined by measuring the phase angle between the current of an inductance coil and the voltage of a capacitor of the oscillating circuit, the resonant frequency corresponding to the frequency when the phase angle is substantially equal to 90°.

The resonant frequency may be determined by minimizing an error function calculated using measurements of electrical indicative values in the oscillating circuit.

The method may further comprise an initialization step comprising determining an initial resonant frequency of the oscillating circuit when the susceptor is at ambient temperature. The resonant frequency in the initialization step may be determined by:
sweeping the frequencies on a range;
measuring an indicative electrical value in the oscillating circuit; and
selecting the resonant frequency within said range when an extremum of said indicative electrical value is obtained.

The estimated or determined temperature of the aerosol-generating device may be the temperature of the susceptor.

The temperature of the susceptor may be estimated or determined using a predefined linear function between the resonant frequency of the oscillating circuit and the temperature of the susceptor, e.g. a predefined linear function in which the resonant frequency at ambient temperature corresponds to the initial resonant frequency. The temperature of the susceptor may also be estimated or determined using a predefined polynomial function between the resonant frequency of the oscillating circuit and the temperature of the susceptor.

The determination or estimation of the temperature may be transitioned to being based on a measured internal temperature of the aerosol-generating device and a predefined offset. In many cases, the temperature of the susceptor cannot be measured directly using a temperature sensor because of its location. For example, the susceptor may be located within the aerosol-generating material. One or more temperature sensors may therefore be arranged adjacent to, or inside, a storage portion of the aerosol-generating device and configured to measure the temperature of the aerosol-generating material and not the temperature of the susceptor. However, the temperature of the aerosol-generating material may differ from the susceptor temperature by an offset which can be determined empirically. It is therefore possible to carry out a heating phase where the heating of the aerosol-generating material is accurately controlled based on internal temperature measurements provided by the temperature sensor(s) and the predefined offset. The predefined offset may be a constant value over time so that the same value of the offset is used during all of the heating phase.

The estimated or determined temperature of the aerosol-generating device is preferably used to control the heating of the susceptor during the pre-heating and heating phases. For example, the estimated or determined temperature may be used by a controller to control operation of the inverter or to vary the output voltage of a power converter such as a boost converter that is connected between a power supply unit and the inverter. It is therefore possible to control the temperature of the aerosol-generating material in an optimal way in order to ensure an optimal user experience.

Heating of the susceptor may be controlled based on a comparison between the estimated or determined temperature of the aerosol-generating device and a target temperature or temperature profile, e.g., a pre-heating temperature profile or heating temperature profile. The temperature profiles for controlling heating can be determined by the user according to their own preferences.

The aerosol-generating device may further comprise a power converter connected between a power supply unit and the inverter. The estimated or determined temperature may be used to vary the output voltage of the power converter or to control the operation of the inverter to control heating of the aerosol-generating material.

According to a second aspect of the present disclosure, there is provided a method for controlling the heating of a susceptor of an aerosol-generating device, the susceptor being inductively heated by an oscillating circuit driven by an inverter.

The method comprises a pre-heating phase of the aerosol-generating device and a subsequent heating phase of the aerosol-generating device, a step of estimating or determining a temperature of the aerosol-generating device being performed during the pre-heating and heating phases, wherein at the start of the pre-heating phase, the estimation or determination of the temperature is based on a first parameter, and wherein the estimation or determination of the temperature is transitioned to being based on a second parameter, different from the first parameter, when the rate of change of the estimated or determined temperature falls below a first predefined value.

The first parameter may be a parameter of the oscillating circuit. The first parameter may be an indicative electrical value of the oscillating circuit or the resonant frequency of the oscillating circuit, for example. The indicative electrical value can be any value that is a function of, or is related or proportional to, the resonant frequency of the oscillating circuit or the operating frequency at which the inverter is driving the oscillating circuit. The indicative electrical value can be for example a current, a voltage or an impedance. The indicative electrical value can be the voltage of a capacitor of the oscillating circuit, for example. The resonant frequency of the oscillating circuit may be determined as described herein.

The second parameter may be a measured internal temperature of the aerosol-generating device and an optional predetermined offset, for example. The second parameter may be a parameter of the oscillating circuit.

The first predefined value may be about 3 to about 7° C./s, and most preferably about 5° C./s.

Further details of the first aspect of the present disclosure are also applicable to the second aspect of the present disclosure.

According to a third aspect of the present disclosure, there is provided an aerosol-generating device comprising:
an induction heatable susceptor;
an oscillating circuit arranged to generate a time varying electromagnetic field for inductively heating the susceptor;
an inverter configured to drive the oscillating circuit;
a temperature sensor for providing internal temperature measurements of the aerosol-generating device; and
a controller adapted to implement the method for controlling the heating of the susceptor as described above.

The aerosol-generating device may further comprise a power converter connected between a power supply unit and the inverter.

The aerosol-generating device may include a storage portion or compartment for storing aerosol-generating material (or vaporizable material). The temperature sensor may be positioned adjacent to or in the storage portion or compartment.

### BRIEF DESCRIPTION OF THE DRAWINGS

FIGS. 1a, 1b represent schematically part of an aerosol-generating device according to two embodiments of the present disclosure;

FIG. 2a represents schematically the electronic circuitry of the aerosol-generating device;

FIG. 2b represents schematically a control loop system according to an embodiment of the present disclosure;

FIGS. 3a, 3b, 3c represent examples of oscillating circuits used for inductive heating in the aerosol-generating device;

FIG. 4a represents a theoretical example of an oscillating circuit that can be used for inductive heating in the aerosol-generating device;

FIG. 4b represents an equivalent circuit of the oscillating circuit of FIG. 4a;

FIGS. 4c, 4d represent a vector representation of currents in the oscillating circuit of FIG. 4b;

FIG. 5 represents a linear dependency between the resonant frequency of the oscillating circuit and the temperature of a susceptor of the aerosol-generating device;

FIGS. 6, 7a and 7b represent the temperature of a susceptor of an aerosol-generating device during a pre-heating and heating phase;

FIGS. 8a and 8b represent flow diagrams of control methods according to the present disclosure; and

FIG. 9 represents a heating controller of an aerosol-generating device.

### DETAILED DESCRIPTION OF EMBODIMENTS

Embodiments of the present disclosure will now be described by way of example only and with reference to the accompanying drawings.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

As used herein, the term “aerosol-generating device” or “device” may include a vaping device to deliver an aerosol to a user, including an aerosol for vaping, by means of an aerosol generating unit (e.g., an aerosol generating element which generates vapor which condenses into an aerosol before delivery to an outlet of the device at, for example, a mouthpiece, for inhalation by a user). The device may be portable. “Portable” may refer to the device being for use when held by a user. The device may be adapted to generate a variable amount of aerosol, e.g. by activating a heater system for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapour to be provided (so as to mimic the effect of smoking a conventional combustible smoking article such as a cigarette, cigar or pipe, etc.).

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

As used herein, the terms “aerosol-generating material” or “vaporizable material” are used to designate any material that is vaporizable in air to form aerosol. Vaporization is generally obtained by a temperature increase up to the boiling point of the vaporization material, such as at a temperature less than 400° C., preferably up to 350° C. The vaporizable material may, for example, comprise or consist of an aerosol-generating liquid, gel, wax, foam or the like, an aerosol-generating solid that may be in the form of a rod, which contains processed tobacco material, a crimped sheet or oriented strips of reconstituted tobacco (RTB), or any combination of these. The vaporizable material may comprise one or more of: nicotine, caffeine or other active components. The active component may be carried with a carrier, which may be a liquid. The carrier may include propylene glycol or glycerin. A flavouring may also be present. The flavoring may include Ethylvanillin (vanilla), menthol, Isoamyl acetate (banana oil) or similar.

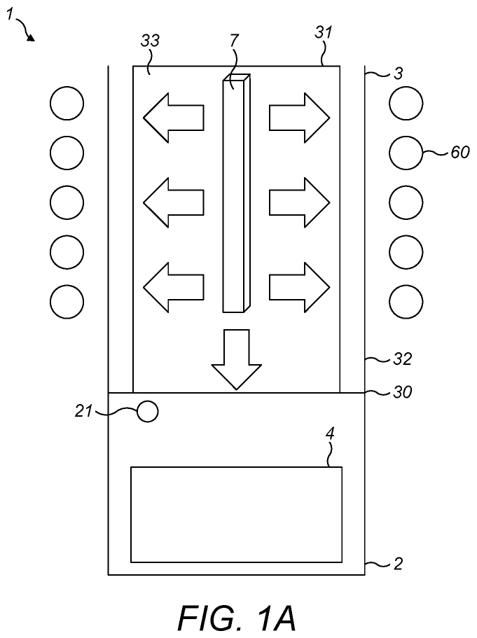

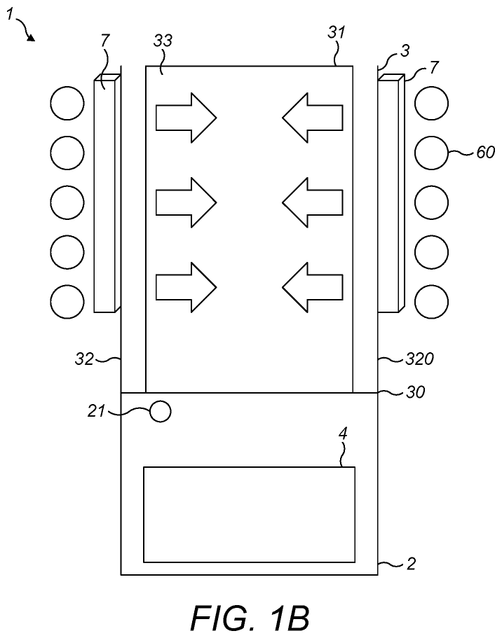

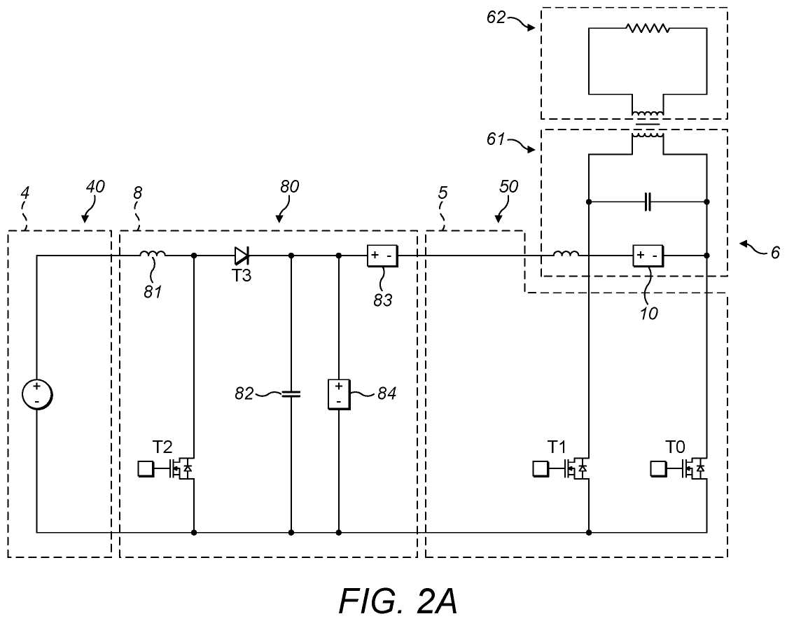

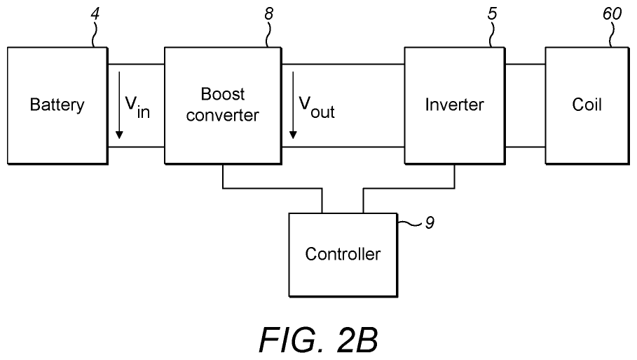

FIGS. 1a and 1b represent schematically part of an aerosol-generating device 1 according to two different embodiments of the present disclosure. Both FIGS. 1a, 1b show schematically the mechanical configuration of the aerosol-generating device, whereas FIG. 2a represents an example of the electronic circuitry of the aerosol-generating device.

An aerosol-generating device generally comprises a main body 2 and a cartridge 3.

The cartridge 3 comprises a first end 30 configured to engage with the body 2 and a second end 31 arranged as a mouthpiece portion (not shown) having a vapor outlet.

The cartridge 3 further comprises at least one reservoir 32 arranged to store an aerosol-generating material 33. The cartridge 3 may be disposable.

The reservoir 32 is arranged to receive a correspondingly shaped aerosol-generating material 33. The aerosol-generating material 33 and/or the reservoir 32 may be a disposable article or a stick.

The mouthpiece is removably mounted to allow access to the reservoir for the purposes of inserting or removing the aerosol-generating material 33.

A heating temperature sensor 21 is configured to measure the temperature of the aerosol-generating material 33. As shown in FIGS. 1a and 1b, the heating temperature sensor 21 can be adjacent to at least one wall of the cartridge housing, for example. The heating temperature sensor may be arranged inside a storage portion of the aerosol-generating device or reservoir 32. The heating temperature sensor may be arranged to be in contact with the aerosol-generating material 33. The heating temperature sensor 21 can correspond to any known sensor, as for example “PT100” sensor.

The aerosol-generating device 1 comprises an induction heating system configured to enable the heating of the aerosol-generating material 33.

The induction heating system comprises a power supply unit or battery 4 as well as an inverter 5 and a controller 9 (visible on FIG. 2b), generally disposed in the body 2.

The inverter 5 is arranged to convert a direct current from the battery 4 into an alternating high-frequency current. The inverter 5 comprises here two switches or transistors, T0, T1. The transistors T0, T1 are operated at the same frequency and at a predefined duty cycle. In particular, the duty cycle of the two transistors T0, T1 of the inverter 5 is equal to 50%.

The induction heating system further comprises an oscillating circuit 6. The oscillating circuit comprises an inductance provided by a coil 60.

The coil 60 is here a helical induction coil which extends around the reservoir 32. The induction coil 60 is energized by the power source unit and the controller.

The induction heating system also comprises one or more induction heatable susceptors 7. A susceptor is an element made in an electrically conducting material and used to heat a non-electrically conducting material.

The induction heatable susceptor 7 can be in direct or indirect contact with the aerosol-generating material 33, such that when the susceptor 7 is inductively heated by the induction coil 60, heat is transferred from the susceptor 7 to the aerosol-generating material, to heat the aerosol-generating material and thereby produce an aerosol.

In the example shown in FIG. 1a, the susceptor 7 extends within the reservoir 32 with the aerosol-generating material 33. The susceptor is preferably arranged inside the aerosol-generating material 33.

In another embodiment shown in FIG. 1b, the susceptor 7 extends outside the aerosol-generating material 33. The susceptor 7 preferably extends along lateral walls 320 of the reservoir 32.

The controller 9 is configured to operate other electronic components among which is the inverter 5.

The controller 9 is arranged to control the oscillating circuit, for example control the voltage delivered to the oscillating circuit from the battery 4, and the operating frequency at which the oscillating circuit is driven.

FIG. 2a represents the battery circuitry 40, the inverter circuitry 50, the oscillating circuit 6 comprising a coil circuit 61 and a susceptor circuitry 62.

The aerosol-generating device 1 also comprises here a boost converter 8, of which the circuitry 80 is represented at FIG. 2a. For some aerosol-generating devices, the boost converter may be omitted so that the inverter 5 is connected directly to the battery 4. Whether a boost converter is required may depend on the properties of the susceptor and the oscillating circuit. If the aerosol-generating device does not include a boost converter, the heating of the susceptor may be controlled by operating the inverter. For example, the inverter may be periodically enabled and disabled (or periodically controlled to be in an On-state and an Off-state) with a duty cycle that can be varied to control the heating of the susceptor. Such operation can be referred to as a “global” pulse width modulation (PWM) control scheme where the time for which the inverter is enabled (or “pulse width”) is varied. During the periods when the inverter is enabled (or in an On-state) the transistors T0, T1 of the inverter 5 can be operated at a predefined duty cycle. Both transistors T0, T1 are turned off during the periods when the inverter is disabled (or in an Off-state)

The boost converter 8 is on the one part connected to the battery 4 and to the other part connected to the inverter 5.

The boost converter 8 is configured to step-up the voltage, i.e. to transform a DC voltage into a DC voltage of a higher value. More precisely, the boost converter 8 is configured to step-up voltage from an input voltage Vᵢₙ supplied from the power supply unit 4 to a higher output voltage Vₒᵤₜ delivered to the inverter 5.

The boost converter 8 is an advantageous solution for increasing voltage with minimal space.

A boost converter is a type of switch mode power supply. In particular, it uses a main switch, for example a transistor to turn part of the circuit on and off at a certain speed. The boost converter 8 comprises an active switch T2 and a passive switch T3.

The active switch T2, or main switch, is here a MOSFET transistor (Metal-oxide Semiconductor Field Effect Transistor). The passive switch T3, or auxiliary switch, is here a diode. The boost converter is thus an asynchronous boost converter.

In another embodiment, the passive switch T3 can be a MOSFET transistor. The boost converter 8 can thus be a synchronous boost converter.

The boost converter 8 further comprises an inductor 81 and a capacitor 82.

The controller 9 is configured here to control the boost converter 8, in particular to control the output voltage delivered to the inverter 5.

FIG. 2b shows an example of a control loop system that can be used in the present disclosure. The controller 9 is connected on the one side to the inverter 5 and on the other side to the boost converter 8.

The controller 9 is for example a proportional-integral-derivative controller (PID controller).

For a more advanced control and better performance, other topologies or controller types can be used. The controller 9 can be for instance a model-based controller. Such a controller has the advantage of taking into account the dynamic response of the system which changes with operating conditions. The model-based controller yields significantly better performance and exhibits a much lower sensitivity to variation in system properties compared to a regular PID controller. It enables for instance a rapid ramping up or ramping down of the temperature when needed.

In yet another particular embodiment, the controller 9 can be a model-predictive controller or a model-based predictive controller. Such a controller is also able to represent the behaviour of a dynamic system and further uses a model of the system to make predictions about the system's future behaviour.

A type of hybrid or mixed control may also be used. For example, if the aerosol-generating device 1 includes a boost converter 8, the boost converter may be controlled by the controller 9 for some operations of the aerosol-generating device (e.g., during pre-heating) while for other operations (e.g., during a heating or vaping phase) the boost converter may be bypassed or disabled and the induction heating of the susceptor 7 is controlled by the inductor, e.g. using the “global” PWM control scheme mentioned above. During pre-heating, more power is needed and the boost converter 8 would be beneficial in providing a higher output voltage for the inverter 5. A higher voltage means a lower current is needed to achieve the same power, which can reduce losses. Afterwards, during a heating phase, less power is needed and there is no need for the boost converter 8. Conducting losses can therefore be reduced by bypassing the boost converter 8.

The induction heating is commonly based on series, parallel or series-parallel resonant principle. The present aerosol-generating device uses series-parallel resonant principle. Furthermore, a commonly used resonant circuit in induction heating is the RLC circuit. However, such a circuit has high losses due to high currents that flow through the components at oscillating frequency. Furthermore, its components need to be large and are expensive.

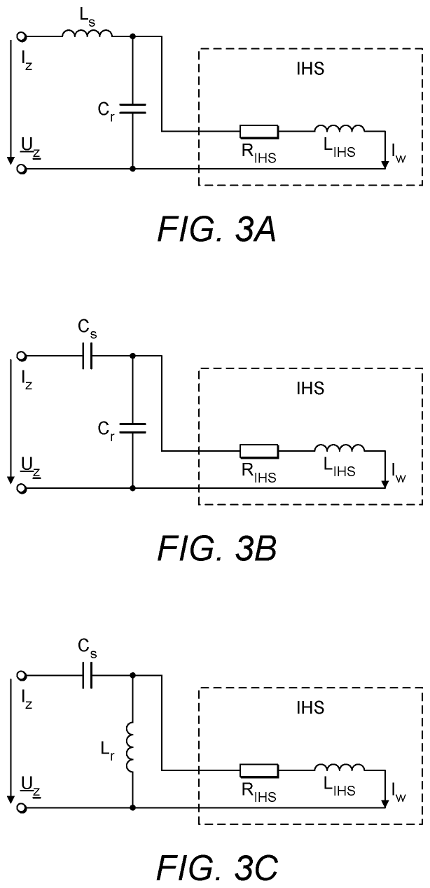

To address these disadvantages, other circuits such as the ones represented on FIGS. 3a, 3b, 3c can be used. Indeed, LLC, LCL and CLL circuits can be used instead of the standard RLC circuit.

LLC, LCL, and CLL circuits have the minimum current draw at resonant frequency operation if operating in parallel resonance and have limited in-rush current. This allows scaling down the components of the circuit to lower values and using smaller components.

These circuits can be digitally controlled, which allows implementation of a measurement of the resonant frequency.

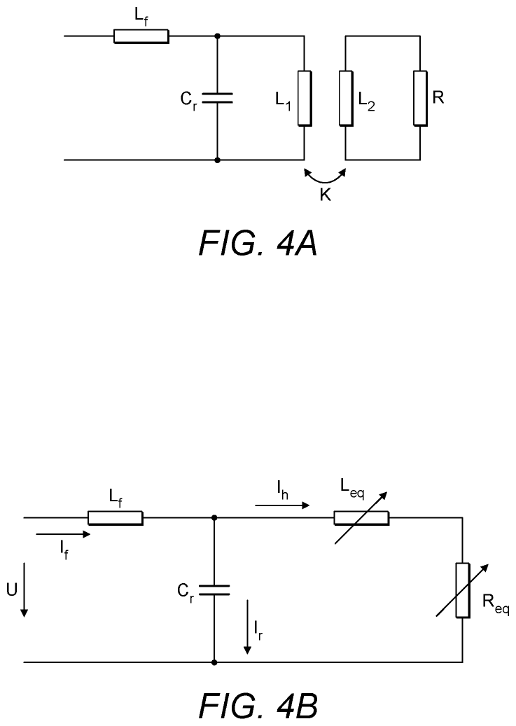

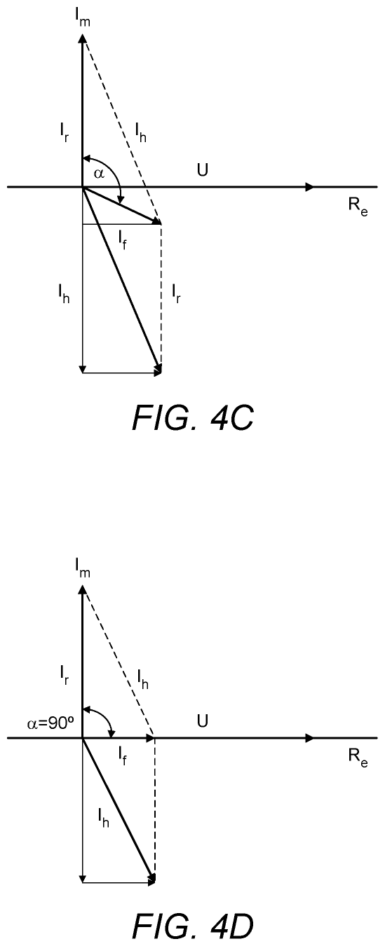

FIG. 4a represents an example of an oscillating circuit of the aerosol-generating device. This oscillating circuit is used for theoretical explanation before explaining the heating control in the aerosol-generating device. The equivalent circuit of induction heating is further transferred to a yet simpler circuit in FIG. 4b.

In order to determine the frequency of the oscillating circuit, it is necessary to determine an indicative electrical value of the oscillating circuit. The indicative electrical value can be any value that is a function of the operating frequency at which the inverter 5 is driving the oscillating circuit. The indicative electrical value can be for example a current, a voltage or an impedance.

In the present embodiment, the indicative electrical value is voltage. The specific reason is that a parallel resonant circuit is implemented. However, as stated above, voltage or impedance can be used as an indicative electrical value depending on the type of oscillating circuit implemented in the system.

The indicative electrical value in the oscillating circuit can be determined using sensors. In the embodiment of FIG. 2a, a voltage sensor 10 is positioned to read the voltage value across the capacitor of the oscillating circuit 6.

The resonant frequency fᵣ of the oscillating circuit is influenced by the values of inductance L, resistance R and capacitance C, and is given as follows:

$${f}_{r} = \frac{1}{2 π} \sqrt{\frac{1}{LC} - {( \frac{R}{L} )}^{2}}$$

The resonant frequency fᵣ of the oscillating circuit depends:
on the exact positioning of the susceptor 7 with respect to the inductance coil 60 of the oscillating circuit 6; and
on the resistance of the susceptor 7 which varies with the temperature of the susceptor. This variation of the resistance can also be influenced by the manufacturing tolerance.

Therefore, the determined resonant frequency of the oscillating circuit 6 can be used to track the change in total resistance and thus the temperature of the susceptor 7.

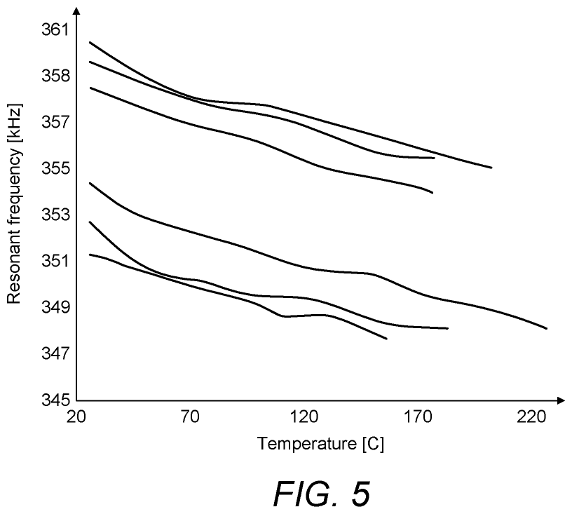

More specifically, the resonant frequency fᵣ varies linearly with the temperature as shown in FIG. 5. A functional form describing the temperature T of the susceptor 7 as a function of frequency characteristic F can be written as F (T)=aT+b, where ‘a’ and ‘b’ are constant parameters of the functional form. The parameter ‘a’ corresponds to the slope value of the curve of frequency. The parameter ‘b’ corresponds to the y-intercept. The functional form can also be a polynomial function. However, in practice the circuitry will normally be optimized such that the aerosol-generating device is operated in a linear area, i.e., a localized linear area of the polynomial function.

The different curves of FIG. 5 represent the variation of the frequency of the oscillating circuit as a function of the temperature and of the position of the susceptor 7. Indeed, as explained above, the resonant frequency depends on the position of the susceptor 7 with respect to the oscillating circuit. This therefore modifies the y-intercept of the curve of the frequency. This appears clearly on FIG. 5 where the slope a is the same for all the curves and the y-intercept is different from one curve to another.

In the illustrated embodiment, the y-intercept or b parameter corresponds to an initial resonant frequency fᵢ of the resonant circuit. The initial resonant frequency fᵢ shall refer to the resonant frequency of the oscillating circuit before heating of the susceptor 7. In other words, it corresponds to resonant frequency when the susceptor 7 is at ambient temperature, i.e. around 20° C.

The illustrated curves thus show that it is possible to take into account an improper insertion of the susceptor 7 in the aerosol-generating device.

The method for controlling heating of the susceptor 7 of the aerosol-generating device 1 according to an embodiment of the present disclosure is now described.

First, the initial resonant frequency fᵢ of the oscillating circuit is determined. This first step is also referred to as an initialization step. The initialization step is performed when the susceptor 7 is at ambient temperature, i.e. before heating it.

For determining the initial resonant frequency fᵢ, a low power energy is supplied to the oscillating circuit. In particular, only the transistor TO of the inverter 5 operates, the transistor T1 being off. The output voltage Vₒᵤₜ of the boost converter is set to a low value, preferably equal to or less than a predefined voltage, e.g. about 8V.

Reducing power delivered to the oscillating circuit 6 enables avoiding power delivery to the susceptor 7.

Then, the frequencies are swept on a range and an indicative electrical value in the oscillating circuit is measured. In practice, the initial resonant frequency fᵢ is selected as the frequency when an extremum of the indicative electrical value is obtained.

An extremum shall mean a minimum or a maximum depending on the type of indicative electrical value that is determined. The resonant frequency corresponds to a maximum voltage or current value, and to a minimum impedance value.

Preferably, the swipe in a range lasts a short period. For example, the swipe lasts at most 50 ms.

Preferably, the frequency swipe is performed several times, for example 4 to 12 times. The determined initial resonant frequency fᵢ is the average value of the obtained resonant frequencies during the multiple swipes.

When heating the susceptor, both transistors T0, T1 of the inverter 5 are operated, typically with a duty cycle of 50%. The output voltage Vₒᵤₜ is normally initially set to a high value. Namely, the output voltage Vₒᵤₜ is set at a desired output voltage. The desired output voltage will be sufficient to generate appropriate losses in the susceptor for required heating and in some aspects the desired voltage may be a value greater than 8V. The desired output voltage may depend on the susceptor properties such as resistance, shape and size etc. The output voltage Vₒᵤₜ may be adjusted to control heating.

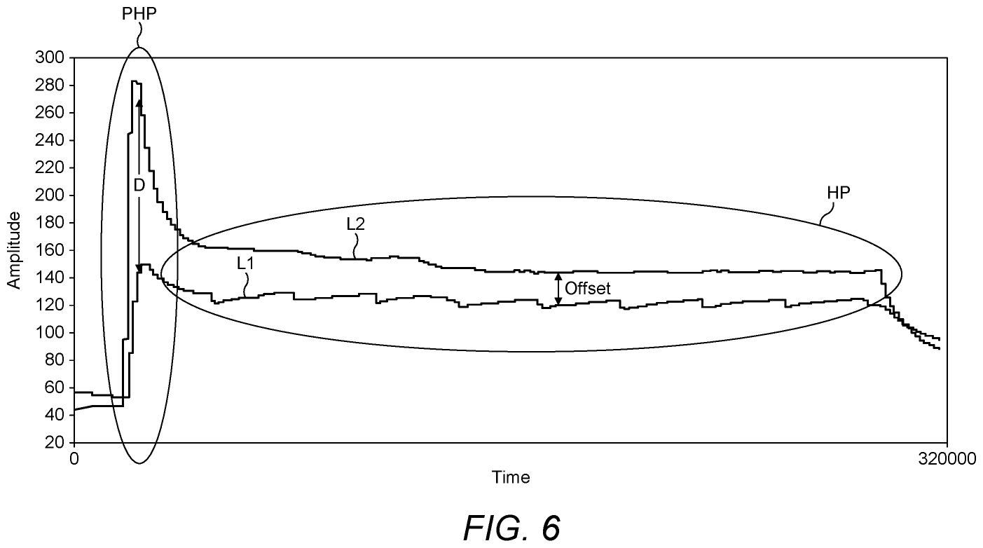

Referring to FIG. 6, a control method for a vaping session includes a pre-heating phase PHP intended to pre-heat the aerosol-generating material 33, and a heating phase HP.

The pre-heating phase PHP is activated by the controller 9 on detecting activation of the vaping button by the user or a trigger event as for example detection of a user puff. During this pre-heating phase PHP, the controller 9 controls the induction heating system to heat the aerosol-generating material 33 based on a predefined pre-heating temperature profile and an estimated temperature of the susceptor 7. This predefined pre-heating temperature profile is for example determined empirically to ensure an optimal user experience. According to another embodiment, the predefined pre-heating temperature profile is chosen by the user according to their own preferences.

At the start of the pre-heating phase PHP, the resonant frequency is continuously tracked and used to estimate the temperature of the susceptor 7.

One method, a direct method, can consist in measuring the phase between the current of the inductance coil and the voltage of the capacitor of the oscillating circuit 6. The resonant frequency fᵣ corresponds to the frequency obtained when the current and the voltage are at 90° phase shift.

Another method, an indirect one, can consist in using the electrical measurements in the oscillating circuit, for example current measurements. This method is described with reference to FIG. 4b which represents the equivalent circuit of induction heating, and FIGS. 4c, 4d which are vector representations of the currents in the equivalent circuit respectively when the latter is being close to phase resonance state and in phase resonance state.

As it can be seen in FIG. 4c, when being close to resonance state, the following relationship is obtained: Iₕ²=Iᵣ²+I_{f}²−2 IᵣI_{f} cos (α), where I_{f} is the inverter current, Iᵣ is the resonant capacitor current, Iₕ is the induction coil current, and α is a phase angle.

As can be seen in FIG. 4d, in resonance state, the phase angle α is equal to 90°. The following relationship is thus obtained: Iₕ²=Iᵣ²+I_{f}².

An error function is defined to track the resonance state. The error function is defined as the difference between a measured or actual induction coil current squared value and the resonant induction coil current squared value. In other words, the error function is expressed as follows: ε=Iₕ²−(Iᵣ²+I_{f}²). It can be also expressed as:

$$ε = {I}_{r}^{2} + {I}_{f}^{2} - 2 {I}_{r} {I}_{f} cos ( α ) - ( {I}_{r}^{2} + {I}_{f}^{2} ) .$$

The error function can be simplified as follows: ε=−2 IᵣI_{f} cos (α).

Therefore, in resonance state when α=90°, the error ε is equal to zero.

When being close to resonance state, the currents can be considered as sinusoidal peak values. The error function can thus be rewritten as follows:

$$ε = \frac{1}{\sqrt{2}} ( {I}_{h , peak}^{2} - ( {I}_{r , peak}^{2} + {I}_{f , peak}^{2} ) .$$

The induction heating system can further comprise an estimator which drives the controller 9 and that is adapted to minimize this error function.

Since the resonant frequency is continuously tracked at the start of the pre-heating phase, the temperature can be continuously determined using the curves of FIG. 5. In practice, the same corresponding curve of the initial resonant frequency is used for determining the temperature of the susceptor.

The curves as represented at FIG. 5 are adapted after initial resonant frequency determination. The curves can be then shifted or not depending on the equation implemented in the controller.

In another embodiment the curves can be implemented as a look-up table. The look-up table can be registered in the memory of the aerosol-generating device.

In an embodiment of the present disclosure, the controller or the aerosol-generating device comprises a memory configured to store data comprising the parameters of the functional form describing the temperature as a function of the frequency characteristic and the position of the susceptor 7.

In practice, once the initial resonant frequency fᵢ is known, the corresponding curve is selected using the fact that the resonant frequency at ambient temperature is equal to the initial resonant frequency fᵢ. The initial resonant frequency fᵢ thus represents a reference frequency which enables the selection of the curve for determination of the temperature of the susceptor 7.

Then, the temperature of the susceptor 7 can be determined thanks to the resonant frequency value by simple reading on the corresponding curve. The temperature is thus updated while the resonant frequency is updated.

Using this method for controlling the heating, the temperature of the susceptor 7 can be continuously and accurately determined at the start of the pre-heating phase when the susceptor temperature is increasing rapidly.

The duration of the pre-heating phase PHP is fixed to a predefined time interval. This duration can be for example less than about 10 seconds. In this case, the controller 9 detects the end of the predefined time interval and starts the heating phase HP. The duration of the pre-heating phase PHP can also be determined dynamically by the controller 9 as a function of the ambient temperature or some other parameter. During the heating phase HP, the controller 9 controls the induction heating system to heat the aerosol-generating material 33 based on a predefined heating temperature profile and an estimated temperature of the susceptor 7. This predefined heating temperature profile is for example determined empirically to ensure an optimal user experience. According to another embodiment, the predefined pre-heating temperature profile is chosen by the user according to their own preferences. The predefined heating temperature profile may be chosen to maintain the same temperature of the aerosol-generating material 33 during the vaping session, or to vary the temperature over time.

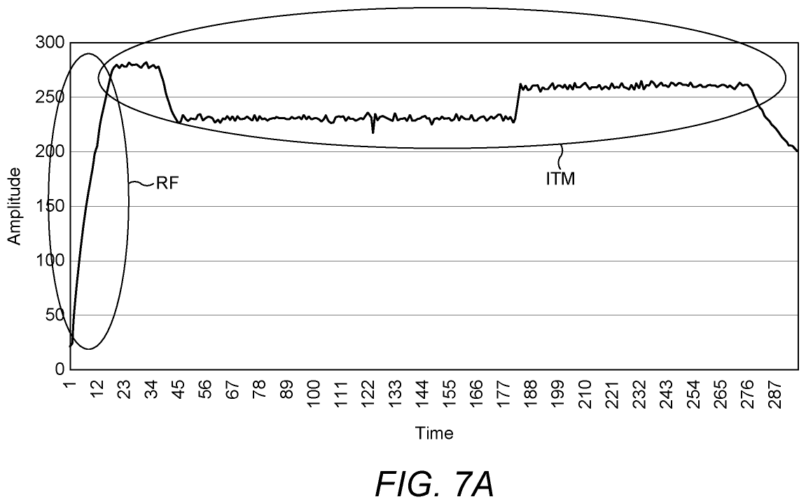

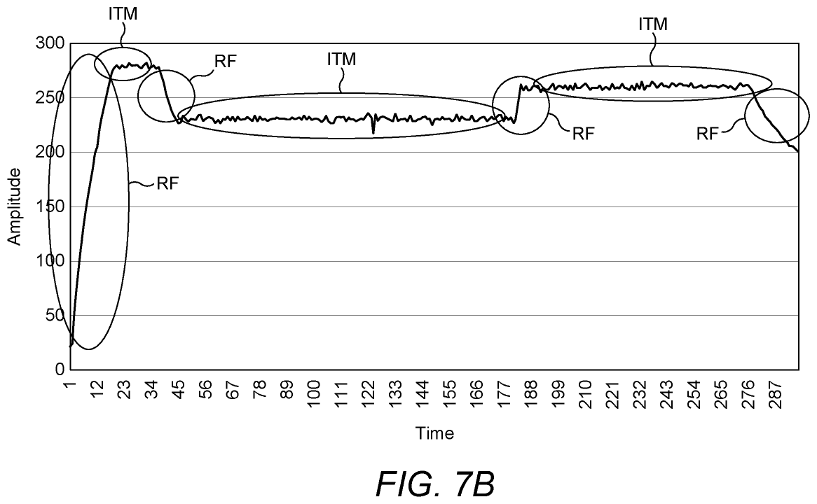

FIGS. 7a and 7b show the periods of time when temperature estimation is based on the determined resonant frequency of the oscillating circuit 6 (labelled “RF”) and on the internal temperature measurements (labelled “ITM”). The rate of change of the estimated temperature is tracked by the controller 9. At the start of the pre-heating phase, the rate of change of the estimated temperature will be relatively high because the susceptor is being heated rapidly. This can be seen in FIGS. 6, 7a and 7b and 8 where the gradient at the start of the pre-heating phase is steep. When the rate of change of the estimated temperature falls below a first predefined value (e.g., about 5° C./s), instead of using the resonant frequency of the oscillating circuit, the temperature of the susceptor 7 can be determined using the internal temperature measurements provided by the heating temperature sensor 21. In the example shown in FIGS. 7a and 7b, the initial transition from using resonant frequency to internal temperature measurements coincides generally with the end of the pre-heating phase. At the start of the heating phase, the temperature of the susceptor is relatively stable for a period of time. The temperature then falls rapidly, becomes relatively stable for a period of time at a lower temperature, rises rapidly, becomes relatively stable for a period of time at a higher temperature, then falls rapidly. In FIG. 7a, during the whole of the heating phase, the controller 9 controls the operation of the induction heating system based on internal temperature measurements provided by the heating temperature sensor 21 and a predefined offset. The predefined offset is shown in FIG. 6 and corresponds to the difference between the temperature of the susceptor 7 and the temperature measured by the heating temperature sensor 21, i.e. temperature measurements of the aerosol-generating material 33. The offset can be a constant value over time or can vary over time. In both cases, the offset can be determined empirically. In some cases, the offset can be a function of at least one characteristic of the aerosol-generating material (e.g., its composition, size and shape) or the device (e.g., the design of the storage portion or susceptor, the susceptor material, the susceptor arrangement in the storage portion etc.). The offset can be proportional to the distance between the susceptor 7 and the temperature sensor 21. In FIG. 6, curve L1 corresponds to the temperature of the aerosol-generating material provided for example by the heating temperature sensor 21 and curve L2 corresponds to temperature measurements of the susceptor 7. It can be seen that the behaviours of curves L1, L2 are very different during the pre-heating and heating phases. Particularly, the susceptor temperature increases significantly during the pre-heating phase in comparison with the aerosol-generating material temperature. Their maximal difference D can be several times greater than the offset during the heating phase. However, as explained above, the susceptor temperature during the pre-heating phase is estimated using the resonant frequency of the oscillating circuit which may provide better accuracy during highly dynamic operation. In the heating phase, the difference between the susceptor temperature and the aerosol-generating material temperature is more regular and can be modelled by the offset. Accurate temperature estimation during the heating phase is therefore carried out using the internal temperature measurements provided by the heating temperature sensor 21 and the predetermined offset.

In FIG. 7b, temperature estimation repeatedly transitions between using resonant frequency and internal temperature measurements. In particular, after the first transition to using internal temperature measurements, the temperature estimation is based on the internal temperature measurements provided by the heating temperature sensor 21. This continues for a period of time when the temperature is relatively stable. But when the temperature of the susceptor falls rapidly, the rate of change of the estimated temperature exceeds a second predetermined value (e.g., about 10° C./s). The temperature estimation will therefore transition to being based on the resonant frequency of the oscillating circuit. It is not important if the estimated temperature is increasing or decreasing, only that the rate of change exceeds the second predetermined value. When the rate of change of the estimated temperature falls below the first predetermined value (e.g., about 5° C./s) and the temperature stabilises at the lower temperature as shown in FIG. 7b, the temperature estimation will transition to being based on the internal temperature measurements. This continues for a period of time when the temperature is relatively stable. But when the temperature of the susceptor rises rapidly, the rate of change of the estimated temperature exceeds the second predetermined value. The temperature estimation will then transition to being based on the resonant frequency of the oscillating circuit. When the rate of change of the estimated temperature falls below the first predetermined value and the temperature stabilises at the higher temperature as shown in FIG. 7b, the temperature estimation will transition to being based on the internal temperature measurements. This continues for a period of time when the temperature is relatively stable. But when the temperature of the susceptor falls rapidly, the rate of change of the estimated temperature exceeds the second predetermined value. The temperature estimation will then transition to being based on the resonant frequency of the oscillating circuit.

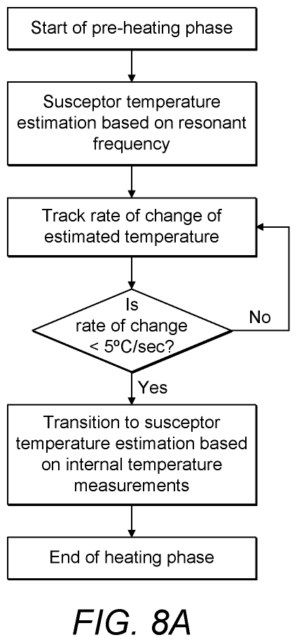

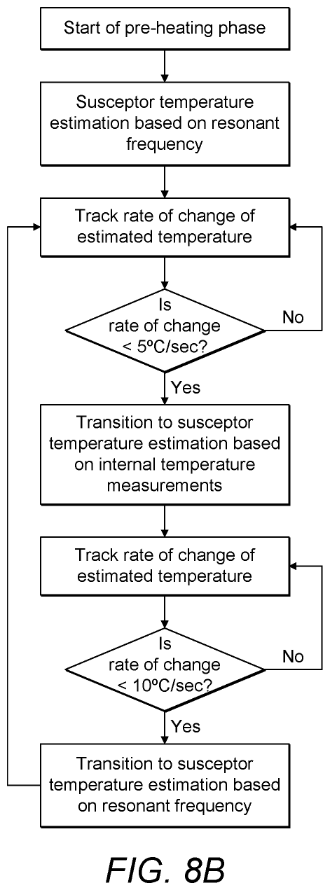

FIGS. 8a and 8b are flow diagrams which show how the temperature of the susceptor is estimated or determined during the pre-heating and heating phases shown in FIGS. 7a and 7b, respectively.

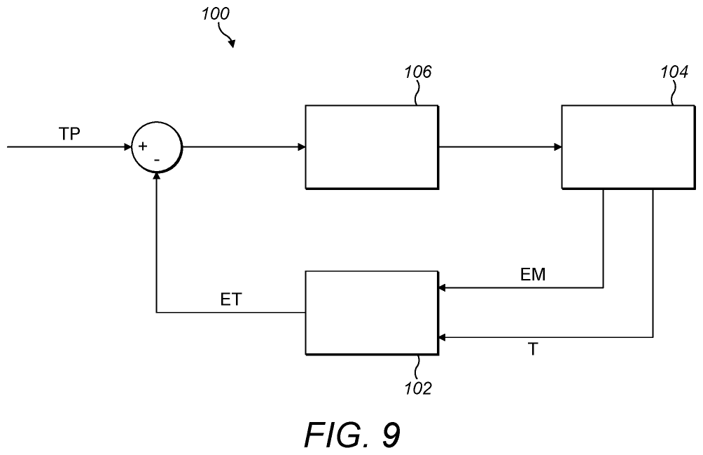

FIG. 9 shows an example of a temperature controller 100 according to the present disclosure.

Internal temperature measurements T from the heating temperature sensor 21 are provided to a temperature estimation block 102. The temperature estimation block 102 also receives electrical measurements EM relating to the oscillating circuit for determining the resonant frequency using the selected curve. (Alternatively, the temperature estimation block may receive a determined resonant frequency from another function block.) The temperature estimation block 102 will output an estimated temperature ET based on: (a) the resonant frequency of the oscillating circuit, or (b) the internal temperature measurements, and is transitioned between calculating and outputting the estimated temperature based on these different inputs depending on the rate of change of the estimated temperature-see FIGS. 8a and 8b, for example. The error E between the estimated temperature ET and a temperature profile TP is calculated and used to control the induction heating system 104. In particular, the error E is provided to a control block 106 which can control the inverter (e.g., by using a “global” PWM control scheme) or vary the output voltage of the boost converter 8.

It should be understood that various changes and modifications to the presently preferred embodiments described herein will be apparent to those skilled in the art. Such changes and modifications can be made without departing from the spirit and scope of the present disclosure and without diminishing its attendant advantages. It is therefore intended that such changes and modifications be covered by the appended claims.

For example, it will be appreciated that other functional forms may be used for the dependency between the resonant frequency and the temperature of the susceptor. For example non-linear functional forms such as polynomial functions parameterized as appropriate can be used.

The present disclosure thus provides a method for controlling inductive heating in an aerosol-generating device that enables optimizing energy efficiency.

The determination of the resonant frequency of the oscillating circuit and temperature of the aerosol-generating material is applicable for any type of susceptor, and takes account of differences in the placement of the susceptor relative to the inductor. Moreover, the temperature determination is compliant with changes of the susceptor, or of any component of the oscillating circuit, the latter being replaceable, for example after a certain use, or after damage.

1. A method for controlling the heating of a susceptor of an aerosol-generating device, the susceptor being inductively heated by an oscillating circuit driven by an inverter, wherein the method comprises a pre-heating phase of the aerosol-generating device and a subsequent heating phase of the aerosol-generating device, a step of estimating or determining a temperature of the aerosol-generating device being performed during the pre-heating and heating phases, wherein at the start of the pre-heating phase, the estimation or determination of the temperature is based on a determined resonant frequency of the oscillating circuit or a determined indicative electrical value of the oscillating circuit, and wherein the determination or estimation of the temperature is transitioned to being based on a measured internal temperature of the aerosol-generating device.

2. The method according to claim 1, wherein the estimation or determination of the temperature is transitioned when the rate of change of the estimated or determined temperature falls below a first predefined value.

3. The method according to claim 1, wherein, after the initial transition, the estimation or determination of the temperature is based on a measured internal temperature of the aerosol-generating device until the end of the heating phase.

4. The method according to claim 1, wherein, after the initial transition, the estimation or determination of the temperature is transitioned to being based on a determined resonant frequency of the oscillating circuit or a determined indicative electrical value of the oscillating circuit if the rate of change of the estimated or determined temperature exceeds a second predefined value.

5. The method according to claim 1, wherein the estimation or determination of the temperature at the start of the pre-heating phase is based on a determined resonant frequency of the oscillating circuit, and wherein the resonant frequency is determined by measuring the phase angle between the current of an inductance coil and the voltage of a capacitor of the oscillating circuit, the resonant frequency corresponding to the frequency when the phase angle is substantially equal to 90°.

6. The method according to claim 1, wherein the estimation or determination of the temperature at the start of the pre-heating phase is based on a determined resonant frequency of the oscillating circuit, and wherein the resonant frequency is determined by minimizing an error function calculated using measurements of electrical indicative values in the oscillating circuit.

7. The method according to claim 1, wherein the estimated or determined temperature of the aerosol-generating device is the temperature of the susceptor.

8. The method according to claim 7, wherein the estimation or determination of the temperature at the start of the pre-heating phase is based on a determined resonant frequency of the oscillating circuit, and wherein the temperature of the susceptor is estimated or determined using a predefined linear or polynomial function between the resonant frequency of the oscillating circuit and the temperature of the susceptor.

9. The method according to claim 1, wherein the estimation or determination of the temperature at the start of the pre-heating phase is based on an indicative electrical value of the oscillating circuit.

10. The method according to claim 1, wherein the determination or estimation of the temperature is transitioned to being based on a measured internal temperature of the aerosol-generating device and a predefined offset.

11. The method according to claim 1, wherein the estimated or determined temperature of the aerosol-generating device is used to control the heating of the susceptor during the pre-heating and heating phases.

12. The A method according to claim 11, wherein heating of the susceptor is controlled based on a comparison between the estimated or determined temperature and a target temperature or temperature profile.

13. The A method according to claim 11, wherein the aerosol-generating device further comprises a power converter connected between a power supply unit and the inverter, and wherein the estimated temperature is used to vary the output voltage of the power converter or to control the operation of the inverter.

14. An aerosol-generating device comprising:
an induction heatable susceptor;
an oscillating circuit arranged to generate a time varying electromagnetic field for inductively heating the susceptor;
an inverter configured to drive the oscillating circuit;
a temperature sensor for providing internal temperature measurements of the aerosol-generating device; and
a controller adapted to implement the method for controlling the heating of the susceptor according to claim 1.

15. The aerosol-generating device according to claim 14, further comprising a power converter connected between a power supply unit and the inverter.

16. The method according to claim 2, wherein the first predefined value is about 3 to about 7° C./s.

17. The method according to claim 4, wherein the second predefined value is about to about 12° C./s.
